(19) United States
(12) Patent Application Publication
(10) Pub. No.: US 2006/0108130 A1
(43) Pub. Date: May 25, 2006

(54) Method for improving landform configuration tracking by an agricultural implement coupled to a tractor

(76) Inventor: Hubert Defrancq, Guignicourt (FR)

Correspondence Address: YOUNG & THOMPSON, 745 SOUTH 23RD STREET, 2ND FLOOR, ARLINGTON, VA, 22202, US

(21) Appl. No.: 10/518,469

(22) PCT Filed: Jun. 13, 2003
(86) PCT No.: PCT/FR03/01780

§ 371 Date: Sep. 19, 2005

(30) Foreign Application Priority Data
Jun. 18, 2002 (FR) 02/07461

(51) Int. Cl. A01B 59/06

(52) U.S. Cl. 172/439

(57) ABSTRACT

A lifting device includes, in its lower part, two arms articulated on a shaft linked to the tractor for attaching two low lateral points of the implement, and in its upper part at least one element linking a third point between the tractor and the implement, the arms being controlled by the lifting element. The linking element has a variable useful length. A device responsive to the angular position of the arms includes a first transducer associated with one arm to deliver an electric signal depending on the angular position of the arm, and at least a second transducer responsive to the length of the third point linking element to deliver an electric signal depending on the length. An electric circuit, with the transducers connected in parallel between a line terminal and the ground connection, mixes the signals from the transducers and deliver the signal, controlling the lifting element.

The invention relates to a device for improving the following of surface undulations by an agricultural implement coupled to a tractor on a three-point lift system which comprises, in the bottom portion, two arms articulated on a shaft connected to the tractor for the coupling of two lateral bottom points of the implement, and in the top portion at least one third point link element between the tractor and the implement, the arms being controlled by lifting means and the third point link element having an effective length which may vary, the device comprising a means responsive to the angular position of at least one arm, provided to act on the position of at least one of the three implement coupling points relative to the tractor, and a means responsive to the length of the third point link element, the assembly being suitable for providing an aggregate signal which serves to control the lifting means.

DE 40 01 495 shows a device of this type. The variation in length of the third point link element is detected by an unspecified measurement device. The position of the lower lift arms is determined by exploring a cam on the lift system shaft. The measurement magnitudes are sent to a regulation apparatus. In such a device, it is not evident that the combination of the measurement magnitudes can be easily and rapidly modified, particularly for an adaptation to the working conditions.

FR-A-2 722 941 shows an agricultural implement control device using the rate of tractor wheel-slip to act on the position of at least one of the three implement coupling points. The third point link element comprises a cylinder of the double-acting type. This cylinder may operate with feed of liquid at low pressure to allow the implement to pivot about the lower coupling points for following of longitudinal undulations, or in locked mode with a constant length, which allows a transfer of load onto the tractor wheels when there is a command to raise the lift system according to the rate of wheel-slip, and improves the traction capability of the tractor.

This device proves satisfactory but does not make it possible to correct the height of the bottom coupling points of the lift system according to the longitudinal variations of the surface undulations.

U.S. Pat. No. 4,508,178 relates to a tractor lift system in which the means responsive to the angular position of at least one arm brings into operation a hydraulic component which acts on the third point link element consisting of a hydraulic cylinder. The command to lift or lower the bottom lift arms is carried out according to the force acting on the third point link element. This device may operate only with a third point hydraulic cylinder and associated hydraulic circuits. Traction efficiency is reduced because a portion of the weight that could be supported by the driving wheels is transferred to non-driving elements, for example the gauge wheel of the implement coupled to the tractor. Also such a device is difficult to adjust, particularly with respect to the volumes of oil transferred from one cylinder chamber to the other. If the means responsive to the angular position of the arms consists of an additional auxiliary cylinder, the positioning of such a cylinder is tricky because there is little space available. When device parameters are chosen, there is no means of modifying the relationship of the movement of the third point relative to the tractor in order to adapt to different implement lengths; one and the same curvature of the ground, a hump or hollow, induces angular variations between the lift system and the implement that differ depending on the length of the implement. The height of the coupling on the implement, or on the tractor, of the third point influences the relationship between the volume of oil displaced in the third point cylinder and the variation of height relating to the movement of the bottom lift arms.

Unlike FR-A-2 722 941, U.S. Pat. No. 4,508,178 does not allow the hydraulic circuit of the third point link element to be dissociated from the hydraulic circuit of the lift system.

The aim of the invention is mainly to alleviate the disadvantages previously exposed and in particular to provide a device to improve the following of surface undulations by an agricultural implement allowing a set-up that is easy and straightforward to reconfigure according to the geometry of the lift system and the nature of the implement. It is also desirable that the device should not cause an unballasting of the tractor by transferring load onto the implement. It is equally desirable that the device allow a load transfer onto the tractor to improve traction capability without introducing a deterioration in operation and without requiring specific calibration.

According to the invention, a device for improving the following of surface undulations by an implement, particularly agricultural, coupled to a tractor on a three point lift system, of the kind previously defined, is characterized in that the responsive means comprises at least a first transducer associated with an arm to deliver an electric signal dependent on the angular position of that arm, and at least one second transducer responsive to the length of the third point link element to deliver an electric signal dependent on that length, in that an electric circuit is provided with the transducers connected in parallel between a power supply terminal and ground, and the signal resulting from the mixing of the signals of the transducers is sent to an input terminal of a comparator, of which another input terminal is connected to ground, the comparator delivering the control signal at its output.

The electric circuit providing the mixing of the transducer signals may modulate the influence of each of the signals according to the components used in the circuit, such that the signal originating from the third point link element may have a different effect in the magnitude of the height variation of the lift system.

The lift system is controlled by comparing the aggregate signal with a setpoint value which may be adjusted at will and modulated according to external parameters, particularly according to the rate of wheel-slip.

The assembly of the transducers, generally consisting of analog sensors with a controller, is used to vary the influence that the signal originating from the sensor of the third point link element has on the degree of reaction of the lift system.

The third point link element may consist of a simple telescopic connecting rod which intervenes to transmit a force only when the implement is fully raised from the soil.

A major advantage of the device of the invention, when the third point link element consists of a cylinder, is that it avoids a hydraulic relationship between the cylinder or cylinders forming the lifting means and the third point cylinder.

The device according to the invention allows the following of surface undulations while allowing the application of a pressure in the third point cylinder in the appropriate chamber to cause this cylinder to shorten.

If it is necessary to transfer the implement to fully mounted mode, the device of the invention allows it without change to its operating principle.

The device of the invention allows an implement to follow perfectly the longitudinal surface undulations and to maintain an even working depth including when the lift system position varies relative to the soil due to the variable compression of the tires or to the presence of a suspension.

The operation of the front and of the rear being independent, this system is perfectly suited to a use of a front or rear implement or of front and rear implements simultaneously.

In addition, this capability is provided without impairing the ability to lift the weight of the implement or implements in order to transfer it to the tractor to improve its traction capability. Specifically, when the hydraulic third point link element is fed by a source at pressure lower than the value necessary to lift the implement, a partial load transfer is obtained while allowing the implement to pivot relative to its bottom coupling points.

The lift system may comprise an intermediate frame with at the top two lateral coupling points and two third point cylinders extending respectively between the two lateral points of the frame and the third point situated on the tractor or the framework fixed to the tractor; two second transducers may be provided, that is to say a second transducer associated respectively with each third point cylinder, to deliver an electric signal dependent on the length of the associated third point cylinder.

The electric signals of all these transducers are mixed in the electric circuit to deliver the aggregate signal to control the lifting means.

The first transducer may consist of a potentiometric sensor having a cursor moved in response to the angular movement of the arm.

The second transducer may also consist of a potentiometric sensor whose cursor is moved in response to the variation in length of the third point link element.

The third point link element usually consists of a telescopic element, a variable length connecting rod or cylinder, comprising two sliding pieces one of which is connected to the tractor and the other is attached to the implement; the potentiometric sensor of the second transducer then comprises a body fixed on one of the pieces with a rotary cursor about the center of the body, this cursor comprising a finger extending radially, while a constant length small rod is articulated at one end on a point of the finger farthest from the center of rotation and, at its other end, on the other piece of the link element.

Other types of sensors, for example potentiometric linear sensors or inductive sensors, may be provided to measure the variation of the length of the third point link element, or the angular position of the lift arms.

The device of the invention may be coupled with a device for controlling the wheel-slip of the tractor comprising a third point hydraulic cylinder fed at low pressure and transferring to constant length locked mode when the rate of wheel-slip exceeds a given limit, thus allowing the transfer of load to the tractor when the arms are commanded to lift.

Apart from the dispositions exposed above, the invention consists of a certain number of other dispositions which will be covered more explicitly hereinafter in relation to exemplary embodiments described with reference to the appended drawings, but which are in no way limiting.

In these drawings:

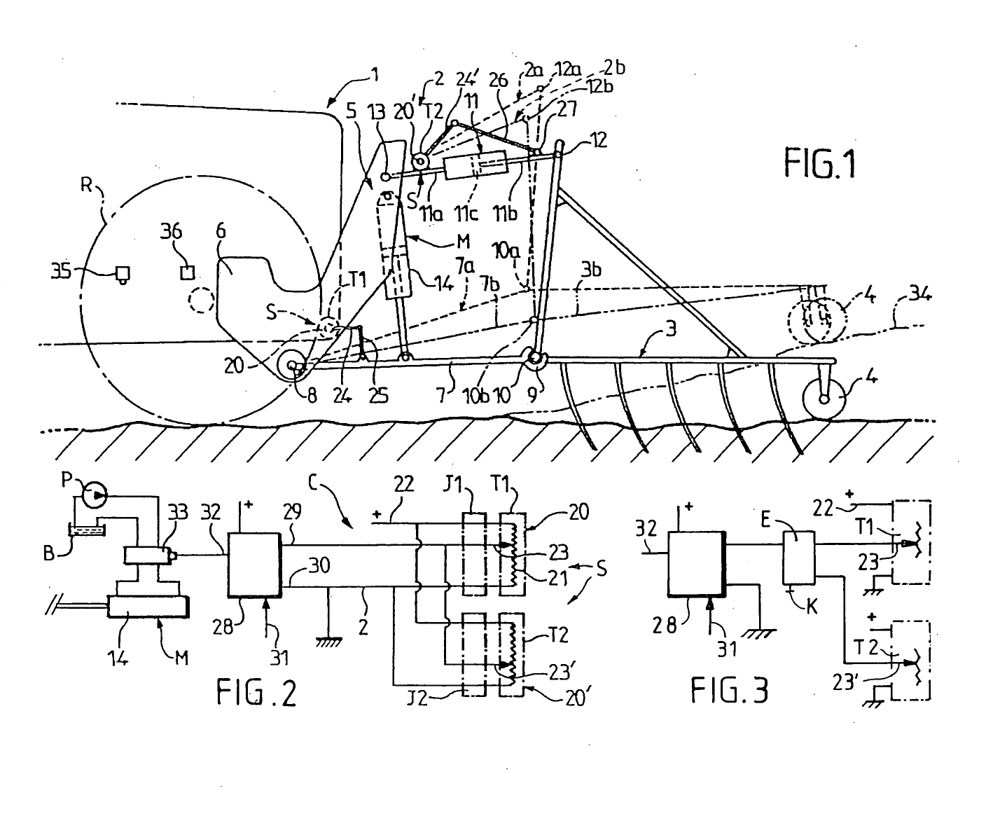

FIG. 1 is a schematic side view of the front of a tractor fitted with a device according to the invention.

FIG. 2 is a simplified diagram of the electric circuit mixing the signals of the transducers.

FIG. 3 is a simplified partial diagram of a variant of the circuit in FIG. 2 mixing the signals of the transducers.

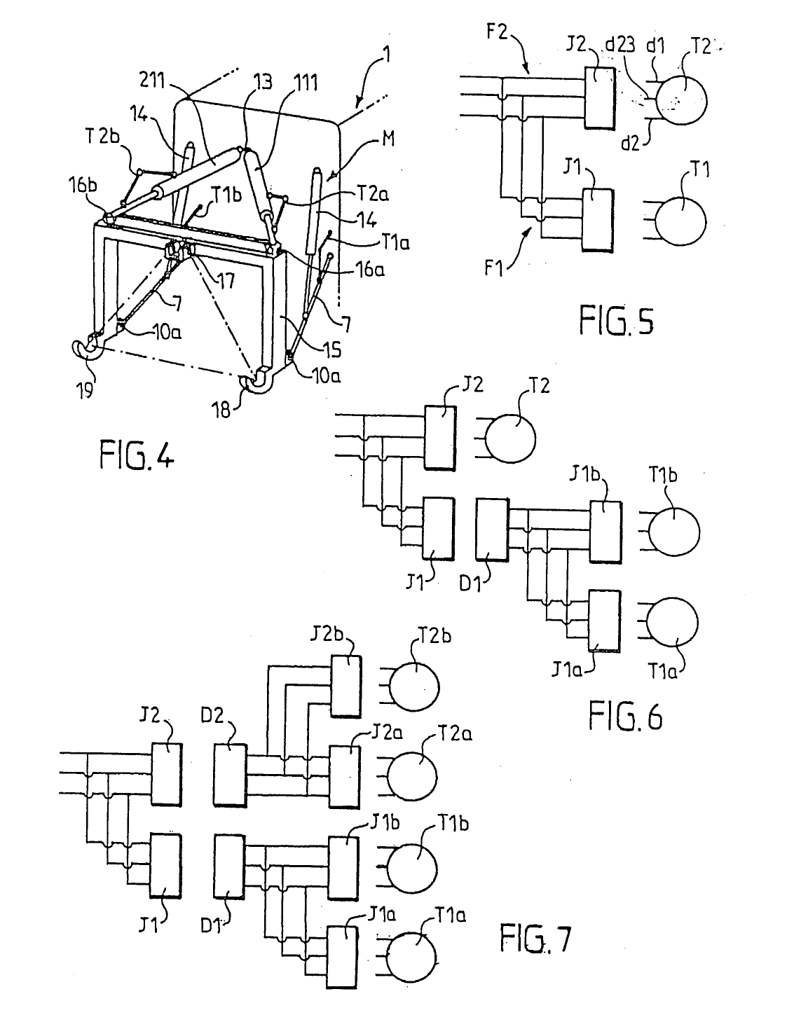

FIG. 4 is a simplified schematic view in perspective of the front of a tractor fitted with a lift system with intermediate frame.

FIG. 5 is a simplified diagram of the connection to the electric circuit of a first transducer and of a second transducer.

FIG. 6 is a simplified diagram of the connection of two first transducers associated respectively with two lift arms and of a second transducer.

FIG. 7 finally, is a simplified diagram of the connection of two first transducers associated with the two lift arms and of two second transducers associated with two third point cylinders according to FIG. 4.

With reference to FIG. 1 of the drawings, a tractor 1 can be seen fitted with a lift system 2 of the three point lift type. In the example shown, the lift system 2 is situated at the front of the tractor and serves for coupling a soil working implement 3 which is pushed by the tractor. This implement is furnished at the front with one or more gauge wheels 4. This exemplary representation is nonlimiting and the invention also applies to lift systems mounted at the rear of the tractor for trailed implements.

The lift system 2 comprises a framework 5 consisting of two flanges such as 6 attached either side of the tractor chassis between the chassis and the front wheel R situated on the same side and which, in reality, masks the rear portion of the framework 5; to make it easier to read the drawing, the wheel R has been represented as a ghosted line so that the rear portion of the framework can also be seen.

The lift system 2 comprises, in the bottom portion of the framework, two arms 7 provided respectively on either side of the tractor chassis and extending in the longitudinal direction of the tractor. In the case of a front lift system, the arms 7 extend forward of the tractor; in the case of a rear lift system, the bottom arms extend rearward of the tractor. The arms 7 are articulated at their end farthest from the implement 3 on a transverse shaft 8 supported by the framework 5 in the bottom portion. The end of the arms 7 facing the implement 3 is furnished with a coupling hook 9 or equivalent means. This hook 9 may receive one of the two bottom lateral coupling points 10 of the implement. Each point 10 usually consists of a shaft attached to the side of the implement and oriented transversely, that is to say perpendicular to the direction of travel of the tractor and of the implement.

In the top portion, a third point link element 11 is provided between the framework 5 and a third point 12 for coupling the implement, usually provided in a vertical longitudinal mid-plane situated between the two lateral bottom coupling points 10.

At its end opposite the third point 12 of the implement, the link element 11 is connected to the third coupling point 13 of the lift system 5. This third point is situated in the top portion and in the mid-zone of the framework 5. The element 11 is linked with the points 12 and 13 by an articulation about a horizontal shaft perpendicular to the longitudinal vertical mid-plane of the tractor.

The third point link element 11 has an effective length that can vary. According to a first possibility, the element 11 consists of two portions 11a, 11b mounted slidably one relative to the other and forming for example a telescopic connecting rod. As a variant, the element 11 may have a constant length and be coupled to a shaft 12 that can slide in a slot provided in the top portion of the implement 3.

The effective length of the element 11 corresponds, to some degree, to the distance between the third point 13 of the lift system and a point of the implement 3 at the height of the shaft 12.

Such a link element 11 whose effective length is variable is not subject to stresses when the implement 3, semi-supported by the gauge wheel or wheels 4, is in work. The third point bar formed by the link element 11 is used only to raise the implement 3 out of the soil for maneuvering.

According to another possibility, the link element 11 consists of a double-acting cylinder with a piston 11c, a cylinder portion 11a and a rod portion 11b connected to the piston 11c. The portion 11b, 11c may slide relative to 11a. The hydraulic circuit supplying the chambers situated either side of the piston 11c is provided to produce at least two configurations. According to a first configuration, the piston 11c may slide in the cylinder, a liquid feed pressure less than the pressure necessary to raise the implement being applied in the chamber whose volume tends to reduce during the raising movement of the lift system, the other chamber being connected to the return without pressure; the cylinder then plays a role similar to that of a telescopic connecting rod, but additionally with partial load transfer of the weight of the implement onto the tractor. According to another configuration, controlled at will (for example as a function of the rate of wheel-slip), a volume of liquid is trapped in the cylinder chamber which tends to reduce in volume during the movement of raising the lift system; the piston 11c is locked such that the length of the element 11 remains constant; this provides a complete load transfer from the implement to the tractor.

The bottom arms 7 are controlled by lifting means M, preferably consisting of one or more double-acting hydraulic cylinders 14, the end of which cylinder (for example) is attached to the framework 5 and the end of the rod is attached to the arm 7. When the rod of the cylinder 14 moves into the cylinder under the effect of the pressure of the liquid, the arms 7 rise, lifting the points 10. The implement 3 may pivot about the lower coupling points 10.

The device comprises a means S responsive to the angular position of at least one arm 7, intended to act on the position of at least one of the three coupling points (10, 12) of the implement and thus to modify the attitude of the implement relative to the tractor.

The responsive means S comprises at least a first transducer T1 suitable for delivering an electric signal dependent on the angular position of the arm 7 and at least a second transducer T2 responsive to the length of the third point link element 11, provided to deliver an electric signal dependent on that length.

In addition, an electric circuit C (FIG. 2) is provided to ensure a mixing of the signals of the transducers T1 and T2 and deliver an aggregate signal which serves to control the lift system cylinder or cylinders 14 or more generally the lifting means M.

With a lift system whose two lateral arms 7 may have different angular movements, in particular may oscillate in opposition to allow a transverse following of the surface undulations, two first transducers T1a, T1b (FIGS. 6 and 7) are advantageously associated respectively with each lateral arm 7, to deliver an electric signal dependent on the angular position of that arm.

As shown by FR-A-2 722 941, the lift system may comprise an intermediate frame 15 (FIG. 4) in the shape of an inverted U. This frame 15 is placed between the three coupling points of the implement and the lift system proper. Two third point cylinders 111, 211 are provided and form between them an angle whose apex corresponds to the third coupling point 13 on the framework, or the tractor. The cylinders 111, 211 are of the double-acting type. The ends of the rods of the cylinders 111, 211 are connected to two lateral coupling points 16a, 16b provided on the top portion of the frame 15, symmetrical in relation to the third coupling point 17 situated in the middle of the top portion of the frame, toward the front. The frame 15 also comprises two lateral bottom coupling points 18, 19 for the bottom points 10 of the implement. In the bottom portion at the rear, on each side, the frame 15 comprises coupling points 10a to which are attached the coupling hooks 9 of the lift system. In this case, two second transducers T2a, T2b (FIGS. 4 and 7) are associated respectively with the third point cylinders 111, 211 to deliver an electric signal dependent on the length of the associated third point cylinder.

Each first transducer T1, or T1a, T1b, may consist of a potentiometric sensor 20 (FIG. 2) comprising a resistor 21 connected between a + power supply terminal 22, for example 12 volts direct current, and ground. The sensor output is supplied by a mobile cursor 23 which may be moved on the electric resistor 21 and is used to draw an electric voltage dependent on its position. The electric resistor 21 is preferably disposed in a circle and the cursor 23 moves angularly along a radius of that circle about the center. The body of the sensor 20 is fixed against the framework 5. The cursor 23 is connected to a finger 24 (FIG. 1) extending radially; the end of the finger farthest from the center of the sensor 20 is connected by an articulation to a small rod 25 of constant length, preferably adjustable, extending substantially vertically and connected at its bottom end, by an articulation, to the arm 7. The finger 24 and the small rod 25 form a sort of pair of compasses whose branches are substantially at right angles when the arm 7 is horizontal. When the arm 7 moves angularly, the finger 24 and the cursor 23 are rotated about the center of the sensor 20.

Each second transducer T2 advantageously consists of a potentiometric sensor 20′ similar to that previously described. The body of the sensor 20′ is fixed to one of the portions, for example 11a, of the element 11. The finger 24′ of the cursor 23′ is connected by an articulation, at its end farthest from the center of the sensor 20′, to a small rod 26 of constant length (preferably adjustable) whose other end is articulated on a point 27 attached to the other portion 11b of the element 11. The opening of the pair of compasses formed by the finger 24 and the small rod 26 depends on the distance between the points 12 and 13, that is to say the effective length of the element 11. The position of the cursor of the sensor T2 will also depend on this length hence an output signal in relation to the length.

According to the diagram of FIG. 2, the signals delivered by the transducers T1 and T2 are mixed by connecting the two cursors 23, 23′ connected in parallel to an input terminal 29, of a comparator 28; another input terminal 30 of the comparator 28 is connected to ground. The two transducers T1 and T2 are connected in parallel between the + terminal 22 and ground. More generally, irrespective of the type of transducer, the transducer outputs are connected in parallel to the terminal 29.

A terminal 31 of the comparator 28 is provided for entering a setpoint value either via a manual command by an operator, or via an automatic command, for example responsive to operating parameters of the tractor, in particular responsive to wheel-slip.

The example in FIG. 2 for the mixing of the output signals of T1 and T2 is nonlimiting. Resistors or amplifiers or other circuits for each signal can be introduced in order to modulate the mixing of the signals and their respective influences.

FIG. 3 partially shows a variant of the circuit in FIG. 2 in which only the modified portions have been represented. The cursors 23, 23′, or outputs of the transducers T1, T2 are connected respectively to two input terminals of an electronic mixer circuit E which can vary the gains of the signals originating from 23, 23′ relative to each other. The influence of T1 and of T2 may thus be modulated. An adjustment means K, in particular manual, of the modulation introduced by E may be provided, particularly to take account of the length of the coupled implement 3, of the distance between the lateral bottom points 10 and the top third point 12, and/or of the type of surface undulation.

The circuit 28 delivers, at its output 32, an aggregate signal which controls, for example, an electrovalve 33 controlling the cylinder or cylinders 14 whose chambers may be linked either to a pump P delivering liquid under pressure or to an unpressurized liquid reservoir, or may be isolated.

The circuit C could comprise a controller or microcomputer to manage the various signals and control the lifting means as a consequence.

The transducers T1, T1a, T1b and T2, T2a, T2b are fitted with three output contact plugs d1, d2, d23 corresponding to the two extreme points of the resistor 21 and to the cursor 23. A connector J1, J2 (not shown in FIG. 3) is provided to make the connection with the contact plugs in question by a movement of translation. Cables F1, F2 furnished at one end with the connectors J1, J2 are connected to the circuit C.

In the case of several transducers T1a, T1b, the corresponding connectors J1a, J1b are provided as illustrated in FIGS. 6 and 7. The signals of the transducers T1a, T1b can be mixed with the aid of the connectors J1a, J1b whose wires are connected together to culminate at an output contact plug D1 which can be connected to the connector J1 (FIG. 6).

A similar arrangement can be provided, as in FIG. 7, for two second transducers T2a, T2b. The connectors J2a, J2b associated with each transducer are connected in parallel to the terminals of the contact plug D2 which may interact with the connector J2.

The connectors J1a, J1b with the output contact plug D1 (just as the connectors J2a, J2b with the output contact plug D2) form a module that can be used to mix two signals. A conventional lift system which comprises only one lift arm transducer T1 with a connector J1 collecting the signal may easily be converted into a lift system according to the invention: a third point transducer T2 is added and the signals of T1 and T2 are mixed by inserting the module J1a, J1b, D1, for example by connecting the transducer T1 to J1a, the transducer T2 to J1b, and linking the contact plug D1 to the connector J1.

The device has great flexibility since the connectors J1, J2 on the tractor may remain unchanged, the variants occurring only at the sensors situated on the lift system.

Depending on the manner in which the parallel connection between the sensors T1 and T2 is achieved, the influence of the signal originating from the third point sensor T2 on the degree of reaction of the lift system can be made to vary.

The operation of the device to improve the following of the surface undulations is schematically illustrated in FIG. 1 in which a rise 34 in the soil, corresponding for example to a hump in the terrain, is represented by dashes.

If the transducer T2 were alone in controlling the lift system cylinder or cylinders 14, the effective length of the link element 11 would remain constant and the point 12 would describe an arc of a circle centered on the point 13 and would come to 12a. The configuration of the lift system would correspond to 2a, 7a illustrated by dashes. The rear portion of the implement 3 would be raised and practically taken out of the soil whereas the depth of work at the gauge wheel 4 would be maintained.

If the transducer T1 alone were to control the lift system cylinder or cylinders 14, each arm 7 would maintain its angular position relative to the tractor and the rear portion of the implement 3 would bury itself too deep in the soil.

According to the invention, since the signal of the transducer T2 is mixed with the signal delivered by the transducer T1, a reduction in the length of the link element 11 is allowed and the arms 7 will lift to the position 7b represented as a dot-and-dash line. In the top portion, the point 12 approaches the point 13 and comes to 12b. The implement 3 comes to 3b and remains substantially parallel to the rising portion 34 of the soil such that the depth of work at the rear of the implement is substantially equal to that which exists at the gauge wheel 4.

In the event of a hollow, and of a downslope portion of the soil, the reverse movements would occur.

The assembly with analog sensors T1, T2, and a controller can be used to vary the influence of the signal originating from the third point element 11 on the degree of reaction of the lifting means M, 14.

An advantage of the device is that it avoids any hydraulic linkage between the lift cylinder or cylinders 14 and the third point cylinder 11.

With this device, it is possible to ensure that an implement perfectly follows the longitudinal surface undulations and maintains an even depth of work including when there is a variation in the position of the lift system relative to the soil due to the variable compression of the tires or to the presence of a suspension.

The operation of the front and of the rear being independent, this device is perfectly suited to a use of a front or rear implement or of front and rear implements simultaneously.

In addition this capability is allowed without impairing the ability to draw off the weight of the implement or implements in order to transfer it to the tractor to improve its traction capability.

Specifically, when the element 11 consists of a double-acting cylinder, its length can be locked when the arms 7 are raised to obtain a transfer of a portion of the load supported by the gauge wheel or wheels 4 onto the tractor in order to improve its traction capability, as specified in FR-A-2 722 941.

In particular, when the tractor is fitted with means of measuring the wheel-slip relative to the ground, the locking of the length of the cylinder 11 may be controlled according to the rate of wheel-slip. The means of measuring the wheel-slip may comprise, for example, a radar 35 attached to the body of the tractor, directed toward the soil, and suitable for delivering the actual speed of the tractor relative to the soil. A sensor 36 is also associated with a drive wheel of the tractor (in the example in question it is assumed that the front wheel R is also a drive wheel, otherwise the sensor 36 is associated with a rear wheel) to count the number of wheel rotations per unit of time and determine, from the perimeter of the wheel, the theoretical speed that the tractor should have in the absence of wheel-slip.

When a rate of wheel-slip greater than a determined limit is detected, control of the locking of the length of the cylinder 11 is provided, which, associated with a lifting of the arms 7, allows the load to be transferred onto the front wheels of the tractor and improve the traction capability.

The invention can be used to correct the height of the lower coupling points 9 of the lift system, while simultaneously allowing a variation of the length of the element 11, thus significantly improving the following of longitudinal surface undulations. In addition, the invention allows the operation of the load transfer system as described in FR-A-2 722 941.

In addition to the longitudinal following of the surface undulations, a transverse following is possible, particularly with the device of FIG. 4.

1. A device for improving the following of surface undulations by an agricultural implement coupled to a tractor on a three-point lift system which comprises, in the bottom portion, two arms (7) articulated on a shaft (8) connected to the tractor for the coupling of two lateral bottom points (10) of the implement, and in the top portion at least one third point link element (11) between the tractor and the implement, the arms (7) being controlled by lifting means (M) and the third point link element (11) having an effective length which may vary, the device comprising a means responsive to the angular position of at least one arm, provided to act on the position of at least one of the three implement coupling points (10, 12) relative to the tractor, and a means responsive to the length of the third point link element (11), the assembly being suitable for providing an aggregate signal which serves to control the lifting means (M),
characterized in that the responsive means (S) comprises at least a first transducer (T1) associated with an arm (7) to deliver an electric signal dependent on the angular position of that arm, and at least one second transducer (T2) responsive to the length of the third point link element (11) to deliver an electric signal dependent on that length, in that an electric circuit (C) is provided with the transducers (T1, T2) connected in parallel between a power supply terminal (22) and ground, and the signal resulting from the mixing of the signals of the transducers (T1, T2) is sent to an input terminal (29) of a comparator (28), of which another input terminal (30) is connected to ground, the comparator (28) delivering the control signal at its output.

2. The device as claimed in claim 1, characterized in that the mixing of signals of the transducers is obtained by a parallel connection of the outputs (23, 23′) of the transducers to the input terminal (29) of the comparator (28).

3. The device as claimed in claim 1, characterized in that the mixing of signals of the transducers is obtained with an electronic mixer circuit (E), the outputs (23, 23′) of the transducers being connected respectively to two input terminals of this electronic mixer circuit (E) which may cause the gains of the signals originating from the outputs (23, 23′) to vary one with the other.

4. The device as claimed in claim 3, characterized in that the mixer circuit (E) comprises a means of adjustment (K) of the modulation introduced by the circuit, in particular to take account of the length of the coupled implement (3), and of the distance between the lateral bottom points (10) and the third top point (12).

5. The device as claimed in claim 1, characterized in that a terminal (31) of the comparator (28) is provided for entering a setpoint value either via a manual command by an operator, or via an automatic command, in particular responsive to wheel-slip.

6. The device as claimed in claim 1, with lift system whose two arms (7) may have different angular movements, in particular to oscillate in opposition, in order to allow a transverse following of the surface undulations, characterized in that the responsive means (S) comprises two first transducers (T1a, T1b), that is to say a first transducer associated with each arm (7) to deliver an electric signal dependent on the angular position of that arm.

7. The device as claimed in claim 1, with lift system comprising an intermediate frame (15) with at the top two lateral coupling points (16a, 16b) and two third point cylinders (111, 211) extending respectively between the two lateral points of the frame and the third point (13) connected to the tractor, characterized in that two second transducers (T2a, T2b) are provided, that is to say a second transducer associated respectively with each third point cylinder (111, 211), to deliver an electric signal dependent on the length of the associated third point cylinder.

8. The device as claimed in claim 1, characterized in that it is coupled with a tractor wheel-slip control device (35, 36) comprising at least a third point hydraulic cylinder (11; 111, 211) fed at low pressure and transferring to constant length locked mode when the rate of wheel-slip exceeds a given limit, thus allowing the transfer of load to the tractor when the arms are commanded to lift.

9. The device as claimed in claim 1, characterized in that the transducers (T1, T1a, T1b and T2, T2a, T2b) consist of potentiometric sensors fitted with three output contact plugs (d1, d2, d23) corresponding to the two extreme points of a resistor (21) and to a cursor (23).

10. The device as claimed in claim 9, characterized in that a connector (J1, J2) is provided to make the connection with the contact plugs, and in that cables (F1, F2) furnished with connectors (J1, J2) at one end are connected to the circuit (C).

11. The device as claimed in claim 9, characterized in that the connectors corresponding to the transducers have their wires connected together to culminate at an output contact plug (D1, D2) to carry out a mixing of the signals of the transducers, the contact plug (D1, D2) being capable of being connected to a connector (J1, J2).

12. The device as claimed in claim 7, characterized in that it comprises connectors (J2a, J2b) associated with each second transducer (T2a, T2b) and connected in parallel to the terminals of a contact plug (D2) which may interact with a connector (J2).

13. The device as claimed in claim 2, with lift system whose two arms (7) may have different angular movements, in particular to oscillate in opposition, in order to allow a transverse following of the surface undulations, characterized in that the responsive means (S) comprises two first transducers (T1a, T1b), that is to say a first transducer associated with each arm (7) to deliver an electric signal dependent on the angular position of that arm.

14. The device as claimed in claim 3, with lift system whose two arms (7) may have different angular movements, in particular to oscillate in opposition, in order to allow a transverse following of the surface undulations, characterized in that the responsive means (S) comprises two first transducers (T1a, T1b), that is to say a first transducer associated with each arm (7) to deliver an electric signal dependent on the angular position of that arm.

15. The device as claimed in claim 4, with lift system whose two arms (7) may have different angular movements, in particular to oscillate in opposition, in order to allow a transverse following of the surface undulations, characterized in that the responsive means (S) comprises two first transducers (T1a, T1b), that is to say a first transducer associated with each arm (7) to deliver an electric signal dependent on the angular position of that arm.

16. The device as claimed in claim 5, with lift system whose two arms (7) may have different angular movements, in particular to oscillate in opposition, in order to allow a transverse following of the surface undulations, characterized in that the responsive means (S) comprises two first transducers (T1a, T1b), that is to say a first transducer associated with each arm (7) to deliver an electric signal dependent on the angular position of that arm.

17. The device as claimed in claim 2, with lift system comprising an intermediate frame (15) with at the top two lateral coupling points (16a, 16b) and two third point cylinders (111, 211) extending respectively between the two lateral points of the frame and the third point (13) connected to the tractor, characterized in that two second transducers (T2a, T2b) are provided, that is to say a second transducer associated respectively with each third point cylinder (111, 211), to deliver an electric signal dependent on the length of the associated third point cylinder.

18. The device as claimed in claim 3, with lift system comprising an intermediate frame (15) with at the top two lateral coupling points (16a, 16b) and two third point cylinders (111, 211) extending respectively between the two lateral points of the frame and the third point (13) connected to the tractor, characterized in that two second transducers (T2a, T2b) are provided, that is to say a second transducer associated respectively with each third point cylinder (111, 211), to deliver an electric signal dependent on the length of the associated third point cylinder.

19. The device as claimed in claim 4, with lift system comprising an intermediate frame (15) with at the top two lateral coupling points (16a, 16b) and two third point cylinders (111, 211) extending respectively between the two lateral points of the frame and the third point (13) connected to the tractor, characterized in that two second transducers (T2a, T2b) are provided, that is to say a second transducer associated respectively with each third point cylinder (111, 211), to deliver an electric signal dependent on the length of the associated third point cylinder.

20. The device as claimed in claim 5, with lift system comprising an intermediate frame (15) with at the top two lateral coupling points (16a, 16b) and two third point cylinders (111, 211) extending respectively between the two lateral points of the frame and the third point (13) connected to the tractor, characterized in that two second transducers (T2a, T2b) are provided, that is to say a second transducer associated respectively with each third point cylinder (111, 211), to deliver an electric signal dependent on the length of the associated third point cylinder.
